(19) United States
(12) Patent Application Publication
(10) Pub. No.: US 2014/0172985 A1
(43) Pub. Date: Jun. 19, 2014

(54) Method and system for forming a hierarchically complete, absent of query syntax elements, valid Uniform Resource Locator (URL) link consisting of a domain name followed by server resource path segment containing syntactically complete e-mail address

(71) Applicant: Anton G Lysenko, Bradenton, FL (US)

(72) Inventor: Anton G Lysenko, Bradenton, FL (US)

(21) Appl. No.: 13/677,254

(22) Filed: Nov. 14, 2012

(51) Int. Cl. H04L 29/08; H04L 12/58

(52) U.S. Cl. CPC H04L 67/06; H04L 51/04; H04L 51/08
USPC 709/206

(57) ABSTRACT

URLs or universal resource locators are used to access resources which can be provided over a communications network such as the Internet. Uniform Resource Identifiers (URIs) are compact strings of characters for identifying abstract or physical resources on network. A computer implemented method is disclosed including forming a hierarchically complete valid uniform resource locator link consisting of a domain name followed by server resource path segment containing syntactically complete e-mail address. The link is absent of query syntax elements.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2012, camcall.me All Rights Reserved.

### TECHNICAL FIELD

The invention generally relates to Web based applications, and in particular, to techniques that support initiation and management of instant connectivity or multimedia content sharing sessions between two or more parties over packet switched protocol networks like the Internet.

### SUMMARY OF THE INVENTION

The aforementioned connectivity needs are addressed by the present invention. The present invention details a process whereby directing a standard HTTP compliant web browser to a URL consisting of a domain name followed by server resource path segment containing syntactically complete e-mail address, all absent of any query syntax elements.

In compliance with RFC 3986 standards, examples of such URL links could be camcall.me/anthony123@gmail.com or shared.by/john.smith@yahoo.com, where camcall.me and shared.by are the corresponding website domain names and e-mail addresses anthony123@gmail.com or john.smith@yahoo.com is the actual name of resource path (or directory name) on the server where the connectivity session initiation application or shared network resources actually reside.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

FIG. 1 depicts a communication network which is suitable for use with one or more embodiments of the invention.

FIG. 2 is a conceptual rendering of sequential steps illustrating one or more embodiments of the invention.

FIG. 3 is a conceptual rendering of sequential steps illustrating one or more embodiments of the invention.

FIG. 4 is a conceptual rendering of sequential steps illustrating one or more embodiments of the invention.

FIG. 5 is a conceptual rendering of sequential steps illustrating one or more embodiments of the invention.

### DETAILED DESCRIPTION

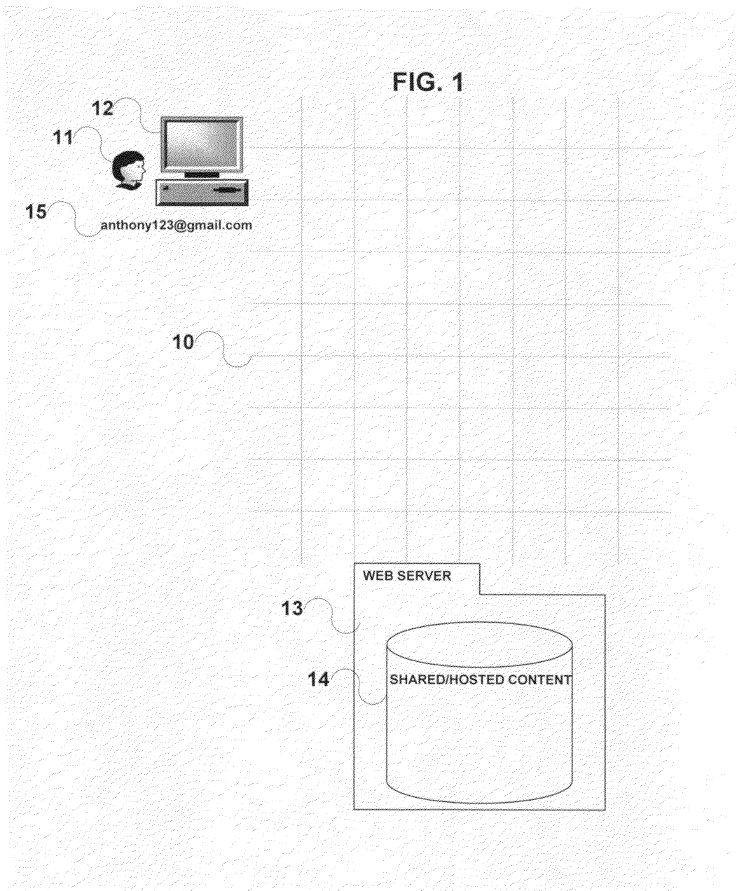

FIG. 1 depicts a communication network 10, which is a packet switched protocol network like LAN, WAN, data connection via cellular network, or the Internet, represented by the interconnected dotted lines. Connected to the network are network user 11 utilizing computing device 12 (a client computer), and a web server 13 hosting certain network accessible content 14. This hosted content could be any type of multimedia (photos, videos, music or a combination of thereof) content or data files (web pages, documents, device drivers, text files, application files, etc), or any other type of content accessible via network. Web server 13 provides connectivity or content sharing services, or any type of service, which is possible to deliver over a network. Although FIG. 1 show all of these content hosting functions being performed within a single web server 13, it is likely that actual embodiments will involve several server computers acting together to satisfy access requests from a large number of clients (users), and employing various server techniques of load balancing, redundancy, content caching, etc, in the process. Similarly, there is a multitude of users accessing services and content of web server 13, while FIG. 1 shows only one such user 11, for simplicity of concept demonstration. User 11 already has e-mail address 15 assigned and available to them prior to web server 13 service signup. Those skilled in art will recognize that existing e-mail address is not a requirement, and web server 13 could create or assign a unique e-mail address to new or existing service user. Any generic e-mail address can be used, while “anthony123@gmail.com” is example for the purposes of concept illustration.

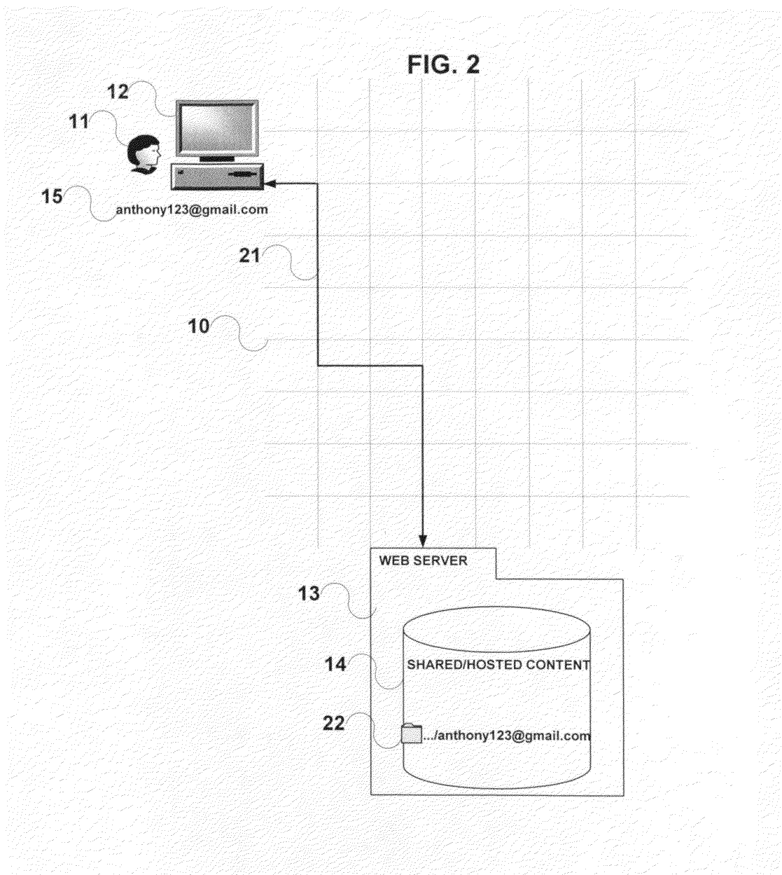

FIG. 2 depicts user 11 connecting to web server 13 via network connection 21. To connect to web server 13 over the network 10, user 11 utilizes local computing device 12 (local client). Further, user 11 signs up for services of web server 13 and in the process of creating their personal user account, user 11 utilizes their e-mail address 15. In response, web server 13 creates a unique server resource path segment 22 containing syntactically complete e-mail address 15. Typically, this is accomplished by creating a hosted/shared subdirectory or a file folder named exactly as user e-mail address. Those skilled in art will recognize that there is a multitude of web content hosting techniques. Some of such web content hosting techniques may or may not result in the actual subdirectory, file folder, or file path to be physically created on the server data storage. However, the final result of the invention is that the server resource path segment is created, said server resource path segment is valid and accessible to other users on network, and said server resource path segment contains syntactically complete e-mail address. Those skilled in art will recognize that there are certain user enrollment techniques that allow for user e-mail address verification and confirmation. In such case, the said server resource path segment containing syntactically complete e-mail address is also an active, verified and existing, proper e-mail address (not a fake or invalid e-mail address, or e-mail address with invalid syntactic structure or disallowed alphanumeric characters). As a result, any shared content in the said server resource path segment is available for access through any generic web browsing application, by entering URL syntax “schema://domain:port/path”. Because “http” schema is already implied in a web browser, and port number segment may be optional, the URL syntax can be further simplified into “domain/path”. For the purposes of concept illustration, the actual web browser URL could be entered as “camcall.me/anthony123@gmail.com”. Those skilled in art will recognize that the server resource path segment can contain a path hierarchy of custom length. For example, “camcall.me/now/anthony123@gmail.com” or “camcall.me/1/2/3/anthony123@gmail.com” are limited examples of varying embodiments of the present invention.

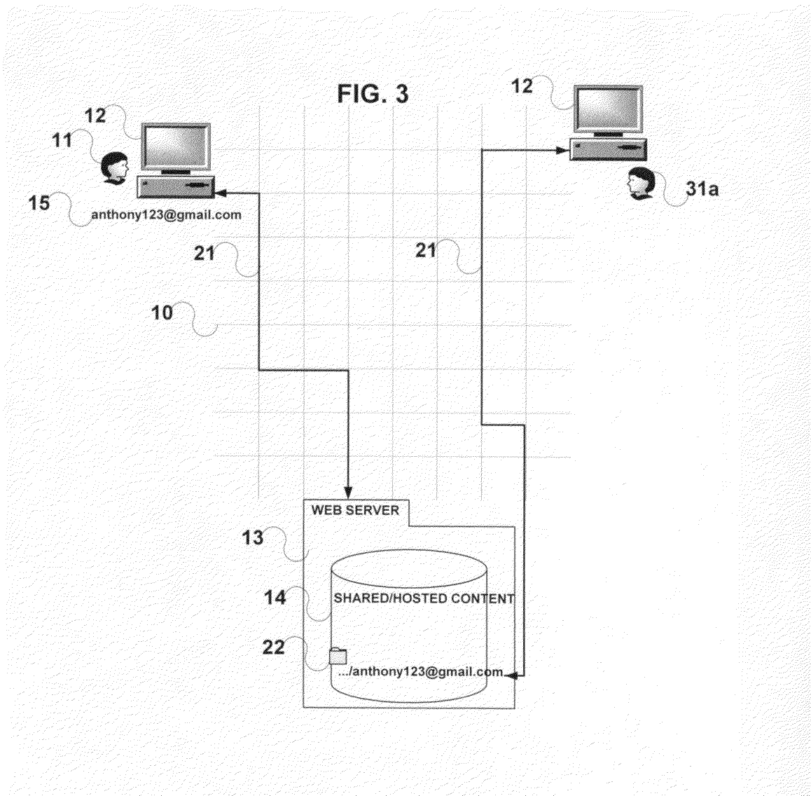

FIG. 3 depicts another network user 31a which utilizes another local computing device 12 (their corresponding local client). User 31a would like to connect to hosted content of user 11, but they don't know how. There is ambiguity of content discovery and user connectivity—searching the Internet can be a lengthy process and may not yield the desired results. Similarly, for user connectivity purposes, user 31a is uncertain which connectivity application or instant messaging platform user 11 utilizes. Further, the two users may be on different connectivity applications or platforms, and are unable to connect to each other. The present invention resolves this issue, if user 31a knows e-mail address 15 of user 11, which can be communicated verbally or through a URL link. Combined with web server name, their connectivity and/or content sharing can be facilitated through the use of any generic web browser. User 31 connects via their network connection 21 directly to the server resource path segment 22, hosted on web server 13. User 31 does this by entering URL “schema://domain:port/path” into a web browser running on their local client 12. For the purposes of concept illustration, the URL could be as simple as “camcall.me/anthony123@gmail.com”.

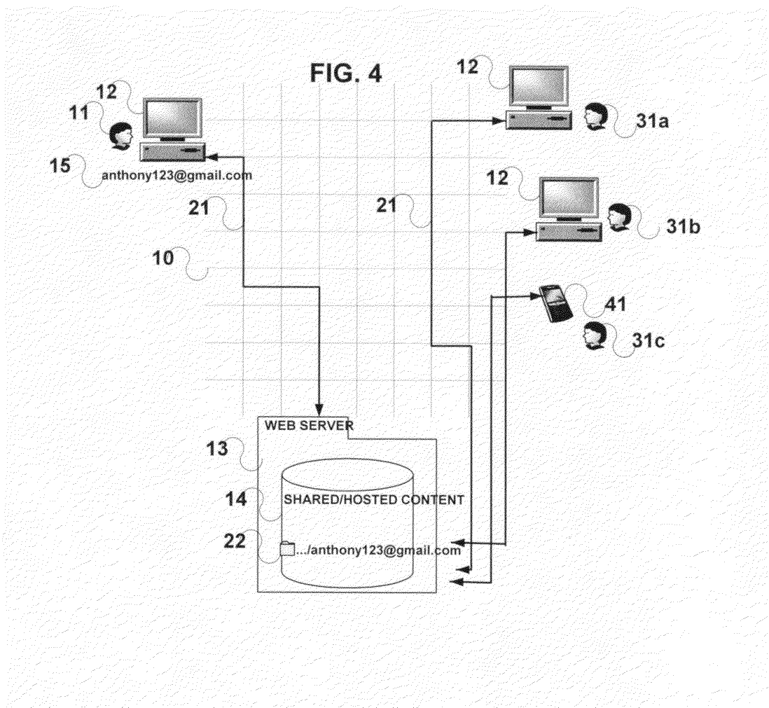

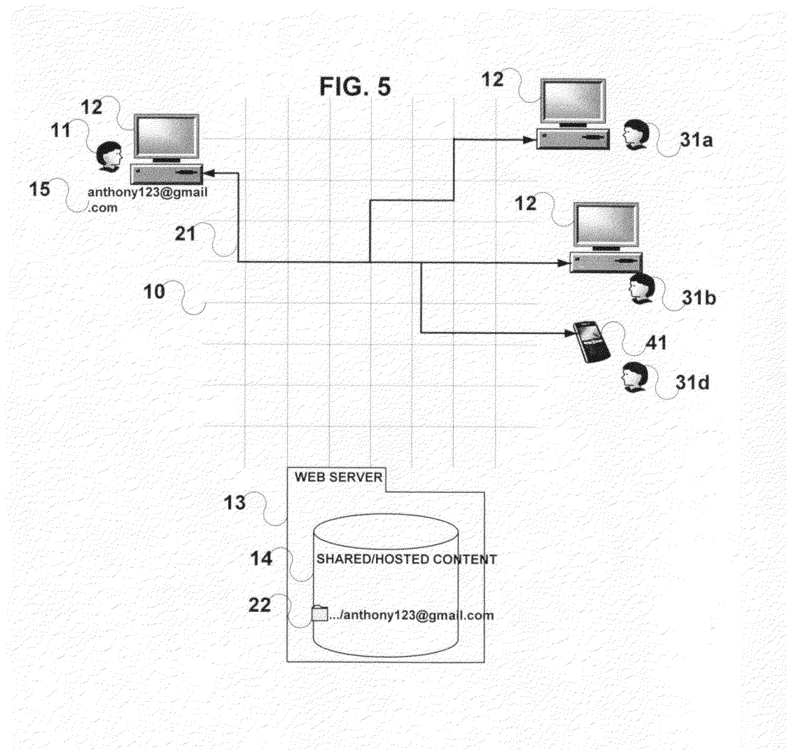

FIG. 4 depicts multiple network users 31a, 31b, 31c connecting directly to the server resource path segment 22, hosted on web server 13. Those skilled in art will recognize that present invention works across different computing platforms, because it is web browser centric and is supported on any generic web browser. User 31c is depicted utilizing a mobile device 41 to connect directly to the server resource path segment 22, hosted on web server 13. Furthermore, the present invention can be utilized for a variety of purposes. Content sharing and interconnectivity are only two embodiments of the present invention, illustrated herein. In another example, a downloadable application or program can be located in the server resource path segment 22, hosted on web server 13, which upon execution connects all users directly to each other, as illustrated on FIG. 5, in which case the server resource path segment 22, hosted on web server 13 plays the role of a pointer for the subsequent real time group connectivity.

For purposes of illustration, users, servers, shared content, programs and other components are illustrated herein as discrete blocks, although it is recognized that such elements reside at various times in different locations and or different networks.

Various embodiments of the present invention described above provide for flexible and generic solution to the problem of multi-user content sharing, real-time interconnectivity, content discovery, user search, and succinct communication of connectivity option or connectivity pointer.

Other advantages of the present invention include:
Present invention does not switch scheme, i.e. it works in any standard web browser in a default http scheme.
Present invention removes syntax ambiguity, as there are no query elements or need for ULR query or complex URL mapping. There are no key-value pairs present to obfuscate syntax structure of URL string.
Present invention is absent of any query string variables, so the URL is simple to communicate verbally, or in writing. It is very effective for memory retention.

Other advantages will be apparent to those skilled in the art.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A computer implemented method comprising:
forming a hierarchically complete, absent of query syntax elements, valid Uniform Resource Locator (URL) link consisting of a domain name followed by server resource path segment containing syntactically complete e-mail address.

2. The computer implemented method of claim 1, wherein the formed URL link is sent using an instant messaging application.

3. The computer implemented method of claim 1, wherein the formed URL link is sent using an e-mail application.

4. The computer implemented method of claim 1, wherein the formed URL link is posted or embedded in a web page or on a web site.

5. A computer implemented method comprising:
forming a hierarchically complete, absent of query syntax elements, valid Uniform Resource Locator (URL) link consisting of a domain name followed by server resource path segment;
wherein said server resource path segment contains syntactically complete e-mail address.

6. The computer implemented method of claim 5, wherein the said syntactically complete e-mail address is confirmed for validity.

7. The computer implemented method of claim 5, wherein the formed URL link is further utilized for the purposes of real time connectivity or content sharing between network users.

8. A memory media having stored thereon a set of instructions which when executed perform a method comprising:
forming a hierarchically complete, absent of query syntax elements, valid Uniform Resource Locator (URL) link consisting of a domain name followed by server resource path segment containing syntactically complete e-mail address.

9. A memory media having stored thereon a set of instructions which when executed perform a method comprising:
forming a hierarchically complete, absent of query syntax elements, valid Uniform Resource Locator (URL) link consisting of a domain name followed by server resource path segment;
wherein said server resource path segment contains syntactically complete e-mail address.
